(19) United States
(12) Patent Application Publication
(10) Pub. No.: US 2009/0265642 A1
(43) Pub. Date: Oct. 22, 2009

(54) SYSTEM AND METHOD FOR AUTOMATICALLY CONTROLLING AVATAR ACTIONS USING MOBILE SENSORS

(75) Inventors: Scott Carter, Los Altos, CA (US); Maribeth Back, Woodside, CA (US); Volker Roth, San Francisco, CA (US)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/105,561

(22) Filed: Apr. 18, 2008

(51) Int. Cl. G06F 3/048

(52) U.S. Cl. 715/757

(57) ABSTRACT

Increasingly people want to maintain a persistent personal presence in virtual spaces (usually via avatars). However, while mobile they tend to devote only short bursts of attention to their mobile device, making it difficult to control an avatar. The core contribution of this IP is to use implicitly sensed context from a mobile device to control avatars in a virtual space that does not directly correspond to the user's physical space. This work allows mobile users to have a presence in a virtual space that matches their environmental conditions without forcing them to configure and reconfigure their virtual presence manually.

### DESCRIPTION OF THE INVENTION

1. Field of the Invention

This invention generally relates to user interfaces and more specifically to using mobile devices and sensors to automatically interact with avatar in a virtual environment.

2. Description of the Related Art

Increasingly, people are using virtual environments for not only entertainment, but also for social coordination as well as collaborative work activities. Person's physical representation in the virtual world is called an avatar. Usually, avatars are controlled by users in real time using a computer user interface. Most users have only a limited amount of time to devote to controlling the avatars. This limits the user's ability to participate in interaction in virtual environments when the user is not at his or her computer. Moreover, in many virtual environments, avatars slump (rather unattractively) when they are not being controlled by the user.

At the same time, people are increasingly accessing social media applications from mobile devices. Unfortunately, it can be difficult to interact with 3D virtual environment applications from a mobile device, not only because devices have limited computing power, but also because of the way people typically interact with mobile devices. In particular, people tend to devote only short bursts of attention to a mobile device, making it difficult to process complicated interfaces such as those typically required for avatar control, see Antti Oulasvirta, Sakari Tamminen, Virpi Roto, Jaana Kuorelahti. Interaction in 4-second bursts: the fragmented nature of attentional resources in mobile HCI. Pages 919-928. CHI 2005.

There are several works wherein virtual objects are directly controlled from a mobile device. In particular, several groups have developed systems to control virtual objects by detecting camera movement, as for example, EyeMobile GesturTek. A similar system is described in Jingtao Wang, Shumin Zhai, John Canny, Camera Phone Based Motion Sensing: Interaction Techniques, Applications and Performance Study, pages 101-110, UIST 2006.

Brown et al. built a system that connects museum visitors across web, mobile and VR spaces, see Barry Brown, Ian Maccoll, Matthew Chalmers, Areti Galani, Cliff Randell, Anthony Steed, Lessons from the lighthouse: collaboration in a shared mixed reality system, Pages 577-584, CHI 2003. In the described system, the mobile system determined the location and orientation of actual participants in the physical building (using ultrasonics) and mapped their movements to avatars in a 3D representation of the museum. Similarly, Bell et al. translated the position of a mobile device (using WiFi sensing) to the position of an avatar on a map of a real space that was overlaid with virtual objects, see Marek Bell, Matthew Chalmers, Louise Barkhuus, Malcolm Hall, Scott Sherwood, Paul Tennent, Barry Brown, Duncan Rowland, Steve Benford, Interweaving mobile games with everyday life, pages 417-426, CHI 2006.

However, the conventional technology fails to enable implicit control of user's avatar in virtual environment based on person's activities in the real world, where there is no direct correspondence between the virtual environment and the real life environment.

### SUMMARY OF THE INVENTION

The inventive methodology is directed to methods and systems that substantially obviate one or more of the above and other problems associated with conventional techniques for controlling person's avatar in a virtual environment.

In accordance with one aspect of the inventive concept, there is provided a method for interacting with an avatar in a virtual environment, the avatar being associated with a user. The inventive method involves implicitly sensing context from a mobile device to control at least one avatar in the virtual environment. In the inventive method, the virtual space does not directly correspond to a physical space of the user.

In accordance with another aspect of the inventive concept, there is provided a system for interacting with an avatar in a virtual environment, the avatar being associated with a user. The inventive system incorporates a mobile device including a mobile sensing module, the mobile sensing module operable to implicitly sense context; a connection module operable to translate the sensed context into avatar commands; and a virtual environment module operable to receive the avatar commands and control the avatar based on the received commands. In the inventive system, the virtual space does not directly correspond to a physical space of the user.

In accordance with another aspect of the inventive concept, there is provided a computer readable medium embodying a set of instructions, the set of instructions, when executed by one or more processors causing the one or more processors to perform a method for interacting with an avatar in a virtual environment, the avatar being associated with a user. The inventive method involves implicitly sensing context from a mobile device to control at least one avatar in the virtual environment. In the inventive method, the virtual space does not directly correspond to a physical space of the user.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates a mobile user using a standard mobile IM interface and the corresponding representation of the user in the virtual environment.

FIG. 2 illustrates an exemplary embodiment of the inventive avatar interaction system.

FIG. 3 illustrates exemplary sensors used in various embodiments of the inventive system, the corresponding avatar actions that the sensors trigger, as well as activity or context for those actions.

FIG. 4 illustrates actions in the virtual environment that trigger actuators on the mobile device 210 as well as activity or context for those actions.

FIG. 5 illustrates an exemplary operational sequence of an embodiment of the inventive avatar interaction system.

FIG. 6 illustrates another exemplary operational sequence of an embodiment of the inventive avatar interaction system.

FIG. 7 illustrates an exemplary embodiment of a computer platform upon which the inventive system may be implemented.

### DETAILED DESCRIPTION

In the following detailed description, reference will be made to the accompanying drawings, in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

Various embodiment of the inventive concept enable user to automatically control user's avatar using mobile sensors. This control may be based, at least in part, on user's actions in real world environment, which may be detected by the aforesaid mobile sensors. To address the avatar interaction problem, the inventive concept introduces a system and method for translating a simple interface appropriate for mobile devices to a complex 3D representation using data sensed implicitly from mobile devices. In particular, the mobile sensors are used to translate a mobile user's actual actions to the actions of their avatar in a 3D world while not forcing the mobile user to manipulate the 3D environment directly. Embodiments of the present invention allow mobile users to have a presence in a virtual space that matches their environmental conditions without forcing them to configure and reconfigure their virtual presence manually.

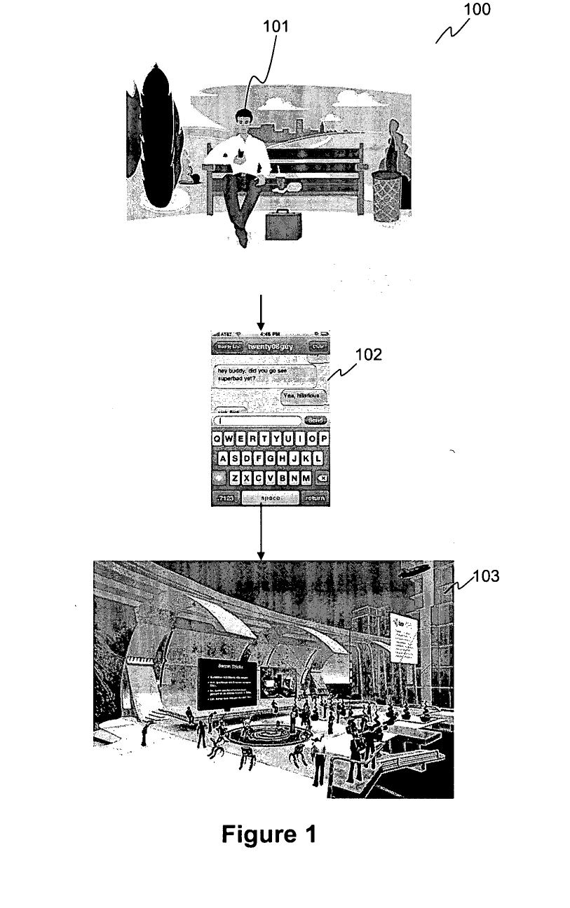

FIG. 1 illustrates a mobile user 101 using a standard mobile IM interface 102. The mobile application 102 automatically senses the user's context and adjusts his avatar in a virtual space 103 accordingly. For example, in one embodiment, the application orients the user's avatar towards people with whom he is chatting, adjusts its head position given the user's attention to the device, and performs other appropriate actions.

A further aspect of maintaining presence in a virtual environment while personally mobile in the real world is understanding feedback from the virtual environment. For example, if another user's avatar attempts to chat with the user's avatar, or otherwise interacts with it (e.g. tapping it on the shoulder) this system translates that action into an event appropriate for display on a mobile device (a vibration, for example). Implicit or environmental aspects of the virtual environments such as density of population, amount of sound, or apparent time of day/night (light levels) may also be translated to a mobile-appropriate display.

It is useful to let other users of a virtual environment know when user's avatar is being implicitly controlled rather than personally, hands-on controlled; otherwise, they might think they are being ignored if they try to interact with the user. A signifier such as an away marker of some sort can serve this function. This can be small, such as a badge or label, or larger, like a bubble around the person's avatar; these markers would likely be fashion statements in themselves. An embodiment of the inventive system allows the avatar's presence to retain a semblance of liveliness, while still letting others know what the real person's state is.

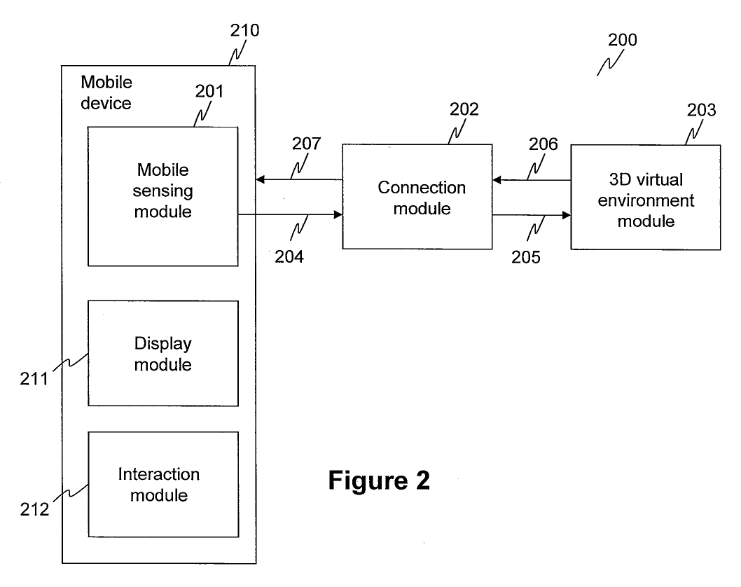

FIG. 2 illustrates an exemplary embodiment of the inventive avatar control system 200. As shown in this figure, this exemplary embodiment of the inventive system incorporates three components: a mobile device 210 having a mobile sensing system 201, a 3D virtual environment module 203, and a connection module 202 that connects the two and abstracts low-level sensing events 204 into events 205 appropriate to drive an avatar in the virtual environment. The connection module 202 also senses in-world events 206 that impact a personal avatar and translates these events appropriately to commands 207 for display on the display module 211 of the mobile device 210. The mobile device 210 also incorporates interaction module 212, which may include various actuators, such as audio device(s), keyboard and haptic interface(s). The interaction module may be used by the user to interact with other avatars in the virtual environment. The inventive concept is not limited to any specific implementation of the components 201-203 and could be implemented with any such components. Exemplary embodiments of the aforesaid three components will be described in detail below.

Mobile sensing module 201 will now be described. An embodiment of the inventive avatar interaction system can work with any mobile sensing application able to read context information. A mobile application could read information available on the mobile device 210 itself, including nearby Bluetooth devices, call and messaging history, and application use information. The mobile sensing application could also access sensors (such as Phidget™ sensors well known to persons of ordinary skill in the art) attached to a built-in USB host. A wide variety of sensors could be attached, including accelerometers, temperature sensors, light sensors, proximity sensors, and the like.

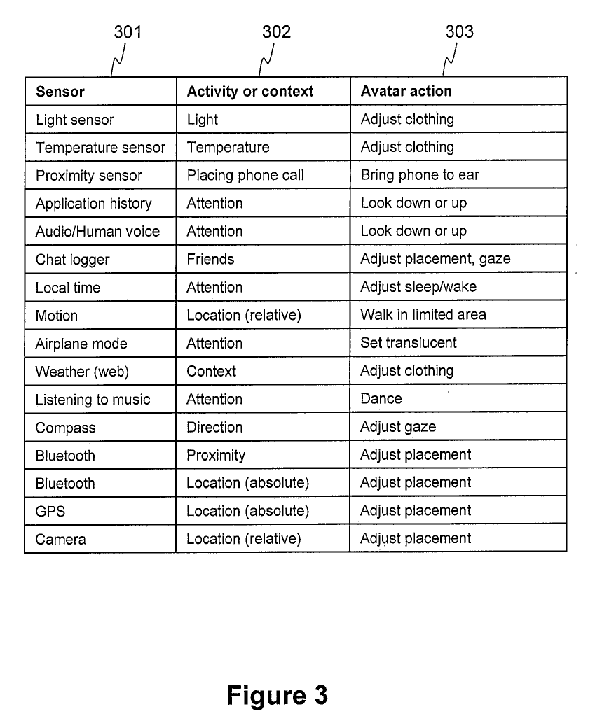

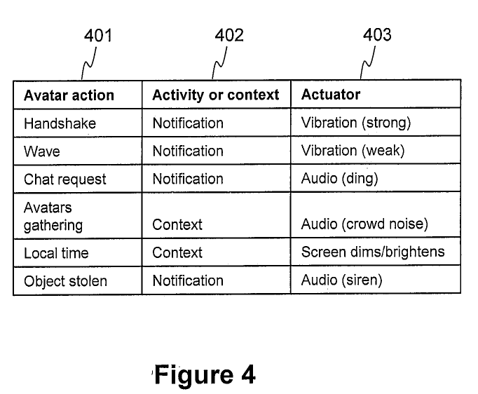

FIG. 3 illustrates exemplary sensors (column 301) used in various embodiments of the inventive system, the corresponding avatar actions (column 303) that the sensors trigger, as well as activity or context for those actions (column 302). FIG. 4 illustrates actions (column 401) in the virtual environment that trigger actuators (column 403) on the mobile device 210 as well as activity or context for those actions (column 402).

An exemplary embodiment of the 3D virtual environment will now be described. Specifically, various embodiments of the inventive system can work with any virtual reality environment that allow avatars to be reconfigurable in real time, such as Project Wonderland, well known to persons of ordinary skill in the art.

The connection module 202 will now be described. Embodiments of the inventive system can work with any messaging infrastructure designed to pass messages between mobile sensors 201 and actuators of the interaction module 212 and the 3D virtual environment module 203. For example, the Wonderland environment can communicate via simple HTTP GET requests.

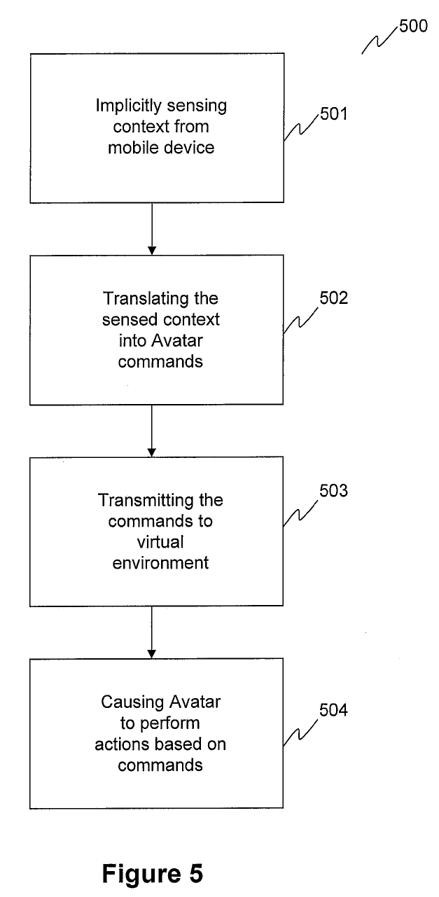

FIG. 5 illustrates an exemplary operating sequence 500 of an embodiment of the inventive system. The sequence 500 corresponds to controlling the avatar based on the context derived from the real life environment. Specifically, at step 501, the mobile sensing module 201 of the mobile device 210 implicitly senses the context of the user. The context is then translated at step 502 into avatar commands. The translation may be performed by the connection module 202 using, for example, the information in the table shown in FIG. 4. At step 503, the avatar commands are transmitted to the virtual environment module 203. At step 504, the avatar performs actions in the virtual space, being directed by the transmitted commands.

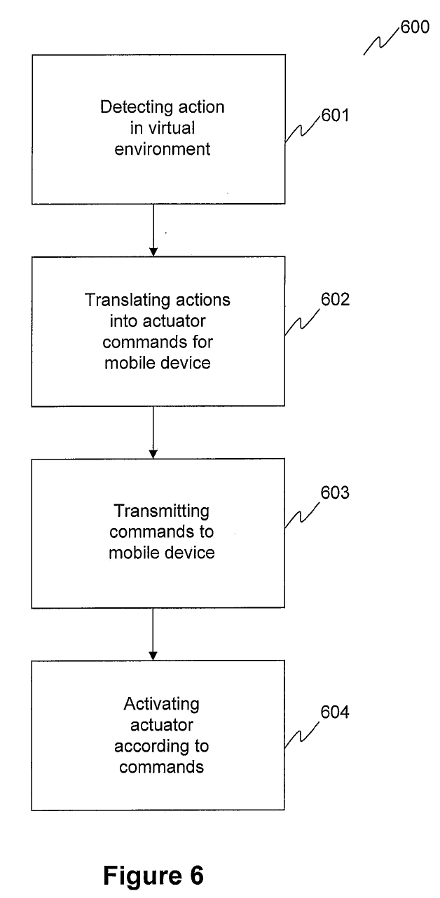

FIG. 6 illustrates an exemplary operating sequence 600 of another embodiment of the inventive system. The sequence 600 corresponds to controlling actuators of the mobile device 210 based on the events in the virtual environment associated with the avatar. Specifically, at step 601, the virtual environment module detects an action in the virtual environment, which is associated with the user's avatar. The detected action is then translated at step 602 into commands for the display or actuator of the mobile device. The translation may be performed by the connection module 202 using, for example, the information in the table shown in FIG. 5. At step 603, the display/actuator commands are transmitted to the mobile device 210. At step 604, the actuator of the interaction module 212 or the display module 211 performs actions that correspond to the virtual environment event(s).

The embodiments of the inventive concept use implicitly sensed context from a mobile device to control avatars in a virtual space that does not directly correspond to the user's physical space. This allows mobile users to have a presence in a virtual space, and allow that presence to reflect activities that match the user's real-world environmental conditions without forcing them to configure and reconfigure their virtual presence manually. It should be noted that in accordance with various embodiments of the inventive system, there is no direct mapping between the virtual space and physical space (e.g., a virtual representation of a real office building). In addition, alternative embodiments of the invention can be configured to map sensor data to absolute positions when there is a direct match between a virtual and physical environment.

### Exemplary Computer Platform

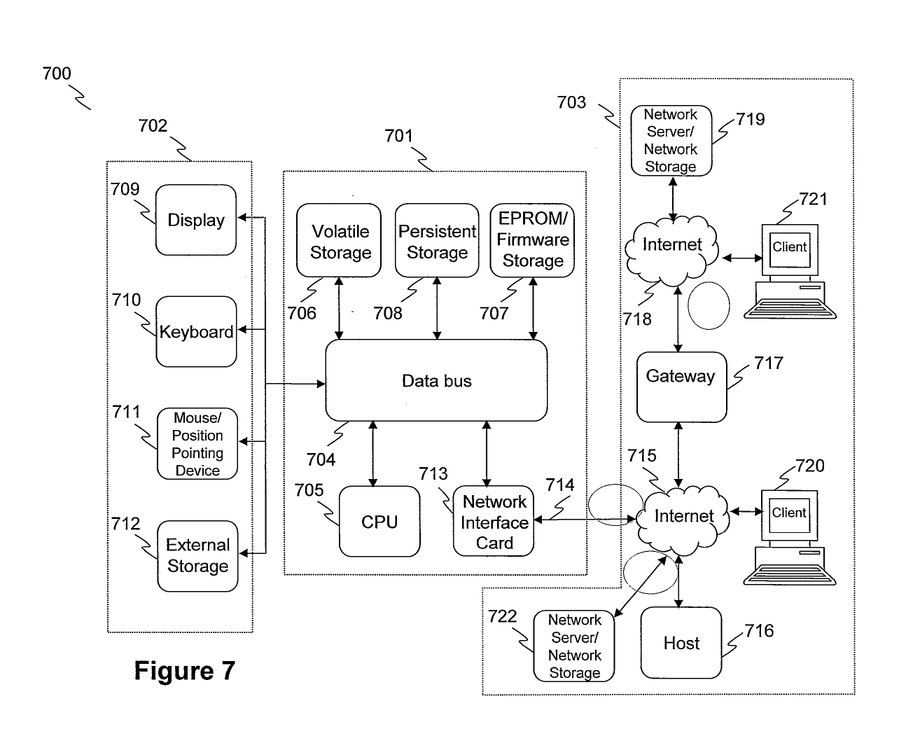

FIG. 7 is a block diagram that illustrates an embodiment of a computer/server system 700 upon which an embodiment of the inventive methodology may be implemented. The system 700 includes a computer/server platform 701, peripheral devices 702 and network resources 703.

The computer platform 701 may include a data bus 704 or other communication mechanism for communicating information across and among various parts of the computer platform 701, and a processor 705 coupled with bus 701 for processing information and performing other computational and control tasks. Computer platform 701 also includes a volatile storage 706, such as a random access memory (RAM) or other dynamic storage device, coupled to bus 704 for storing various information as well as instructions to be executed by processor 705. The volatile storage 706 also may be used for storing temporary variables or other intermediate information during execution of instructions by processor 705. Computer platform 701 may further include a read only memory (ROM or EPROM) 707 or other static storage device coupled to bus 704 for storing static information and instructions for processor 705, such as basic input-output system (BIOS), as well as various system configuration parameters. A persistent storage device 708, such as a magnetic disk, optical disk, or solid-state flash memory device is provided and coupled to bus 701 for storing information and instructions.

Computer platform 701 may be coupled via bus 704 to a display 709, such as a cathode ray tube (CRT), plasma display, or a liquid crystal display (LCD), for displaying information to a system administrator or user of the computer platform 701. An input device 710, including alphanumeric and other keys, is coupled to bus 701 for communicating information and command selections to processor 705. Another type of user input device is cursor control device 711, such as a mouse, a trackball, or cursor direction keys for communicating direction information and command selections to processor 704 and for controlling cursor movement on display 709. This input device typically has two degrees of freedom in two axes, a first axis (e.g., x) and a second axis (e.g., y), that allows the device to specify positions in a plane.

An external storage device 712 may be connected to the computer platform 701 via bus 704 to provide an extra or removable storage capacity for the computer platform 701. In an embodiment of the computer system 700, the external removable storage device 712 may be used to facilitate exchange of data with other computer systems.

The invention is related to the use of computer system 700 for implementing the techniques described herein. In an embodiment, the inventive system may reside on a machine such as computer platform 701. According to one embodiment of the invention, the techniques described herein are performed by computer system 700 in response to processor 705 executing one or more sequences of one or more instructions contained in the volatile memory 706. Such instructions may be read into volatile memory 706 from another computer-readable medium, such as persistent storage device 708. Execution of the sequences of instructions contained in the volatile memory 706 causes processor 705 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 705 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 708. Volatile media includes dynamic memory, such as volatile storage 706. Transmission media includes coaxial cables, copper wire and fiber optics, including the wires that comprise data bus 704. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 705 for execution. For example, the instructions may initially be carried on a magnetic disk from a remote computer. Alternatively, a remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on the data bus 704. The bus 704 carries the data to the volatile storage 706, from which processor 705 retrieves and executes the instructions. The instructions received by the volatile memory 706 may optionally be stored on persistent storage device 708 either before or after execution by processor 705. The instructions may also be downloaded into the computer platform 701 via Internet using a variety of network data communication protocols well known in the art.

The computer platform 701 also includes a communication interface, such as network interface card 713 coupled to the data bus 704. Communication interface 713 provides a two-way data communication coupling to a network link 714 that is connected to a local network 715. For example, communication interface 713 may be an integrated services digital network (ISDN) card or a modem to provide a data communication connection to a corresponding type of telephone line. As another example, communication interface 713 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 713 sends and receives electrical, electromagnetic or optical signals that carry digital data streams representing various types of information.

Network link 713 typically provides data communication through one or more networks to other network resources. For example, network link 714 may provide a connection through local network 715 to a host computer 716, or a network storage/server 717. Additionally or alternatively, the network link 713 may connect through gateway/firewall 717 to the wide-area or global network 718, such as an Internet. Thus, the computer platform 701 can access network resources located anywhere on the Internet 718, such as a remote network storage/server 719. On the other hand, the computer platform 701 may also be accessed by clients located anywhere on the local area network 715 and/or the Internet 718. The network clients 720 and 721 may themselves be implemented based on the computer platform similar to the platform 701.

Local network 715 and the Internet 718 both use electrical, electromagnetic or optical signals that carry digital data streams. The signals through the various networks and the signals on network link 714 and through communication interface 713, which carry the digital data to and from computer platform 701, are exemplary forms of carrier waves transporting the information.

Computer platform 701 can send messages and receive data, including program code, through the variety of network(s) including Internet 718 and LAN 715, network link 714 and communication interface 713. In the Internet example, when the system 701 acts as a network server, it might transmit a requested code or data for an application program running on client(s) 720 and/or 721 through Internet 718, gateway/firewall 717, local area network 715 and communication interface 713. Similarly, it may receive code from other network resources.

The received code may be executed by processor 705 as it is received, and/or stored in persistent or volatile storage devices 708 and 706, respectively, or other non-volatile storage for later execution. In this manner, computer system 701 may obtain application code in the form of a carrier wave.

It should be noted that the present invention is not limited to any specific firewall system. The inventive policy-based content processing system may be used in any of the three firewall operating modes and specifically NAT, routed and transparent.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized system with avatar interaction functionality. It is intended that the specification and examples be considered as exemplary only, with a true scope and spirit of the invention being indicated by the following claims.

What is claimed is:

1. A method for interacting with an avatar in a virtual environment, the avatar being associated with a user, the method comprising implicitly sensing context from a mobile device to control at least one avatar in the virtual environment, wherein the virtual space does not directly correspond to a physical space of the user.

2. The method of claim 1, further comprising providing a feedback from the virtual environment to the user using the mobile device.

3. The method of claim 1, wherein sensing the context comprises sensing at least one parameter using at least one mobile sensor.

4. The method of claim 3, wherein the at least one parameter comprises an ambient parameter.

5. The method of claim 3, wherein the at least one parameter comprises a user activity.

6. The method of claim 1, further comprising providing a feedback from the virtual environment to the user using the mobile device.

7. The method of claim 6, wherein the feedback is a visual feedback.

8. The method of claim 6, wherein the feedback is an audio feedback.

9. The method of claim 6, wherein the feedback is a haptic feedback.

10. A system for interacting with an avatar in a virtual environment, the avatar being associated with a user, the system comprising:
a. A mobile device comprising a mobile sensing module, the mobile sensing module operable to implicitly sense context;
b. A connection module operable to translate the sensed context into avatar commands; and
c. A virtual environment module operable to receive the avatar commands and control the avatar based on the received commands, wherein the virtual space does not directly correspond to a physical space of the user.

11. The system of claim 10, wherein the virtual environment module is further operable to detect an event in the virtual space, the event being associated with the avatar, and furnish information on the event to the connection module.

12. The system of claim 11, wherein the connection module is further operable to translate the information on the event into an actuator command.

13. The system of claim 12, wherein the mobile device comprises an actuator operable to perform the actuator command.

14. The system of claim 13, wherein the actuator is a visual display device.

15. The system of claim 13, wherein the actuator is an audio interface device.

16. The system of claim 13, wherein the actuator is a haptic interface device.

17. The system of claim 10, wherein the virtual environment module is further operable to detect an event in the virtual space and to provide a feedback to the user using the mobile device based on the detected event.

18. The method of claim 10, wherein sensing the context comprises sensing at least one parameter using at least one mobile sensor.

19. The method of claim 18, wherein the at least one parameter comprises an ambient parameter.

20. The method of claim 18, wherein the at least one parameter comprises a user activity.

21. A computer readable medium comprising a set of instructions, the set of instructions, when executed by one or more processors causing the one or more processors to perform a method for interacting with an avatar in a virtual environment, the avatar being associated with a user, the method comprising implicitly sensing context from a mobile device to control at least one avatar in the virtual environment, wherein the virtual space does not directly correspond to a physical space of the user.
